(19) United States
(12) Patent Application Publication
(10) Pub. No.: US 2014/0087064 A1
(43) Pub. Date: Mar. 27, 2014

(54) TOUCH SCREEN PANEL AND METHOD OF PREPARING THE SAME

(71) Applicant: DONGWOO FINE-CHEM CO., LTD., Jeollabuk-do (KR)

(72) Inventors: Yong-Seok CHOI, Jeollabuk-do (KR); Won-Young CHANG, Daejeon (KR); Ji-Min CHUN, Jeollabuk-do (KR)

(73) Assignee: DONGWOO FINE-CHEM CO., LTD., Jeollabuk-do (KR)

(21) Appl. No.: 13/971,856

(22) Filed: Aug. 21, 2013

(30) Foreign Application Priority Data
Sep. 21, 2012 (KR) 10-2012-0104978
Aug. 8, 2013 (KR) 10-2013-0094019

(51) Int. Cl. G06F 1/16

(52) U.S. Cl. CPC G06F 1/1692
USPC 427/122; 427/58; 427/126.3; 427/123

(57) ABSTRACT

A method for preparing a touch screen panel includes forming a non-conductive pattern on a non-display part on one face of a window plate, so that the thickness of the non-conductive pattern is decreased to produce a thin touch screen panel. In addition, this will prevent leakage of ink through the holes of the window plate, and improve the reliability of a conductive electrode pattern layer at a lateral side of the non-conductive pattern, thereby reducing failure rates.

### CROSS REFERENCE TO RELATED APPLICATIONS AND CLAIM OF PRIORITY

This application claims priority to Korean Patent Application No. 10-2012-0104978, filed on Sep. 21, 2012 and Korean Patent Application No. 10-2013-0094019, filed on Aug. 8, 2013, in the Korean Intellectual Property Office, the entire disclosure of which is incorporated herein by reference.

### BACKGROUND

1. Field of the Invention

The present invention relates to a method for preparing a touch screen panel.

2. Description of the Related Art

A touch screen is a screen equipped with a special input device to receive positional input by touching of the screen with, for example, a finger or a stylus pen.

The touch screen does not use a keyboard, but when a human finger or an object, such as a stylus pen touches a specific character or position displayed on a screen, identifies the touched position and directly transmits data through a screen picture, thereby practically processing the data with appropriate software stored therein.

A window-integrated touch screen panel is fabricated by forming a non-conductive pattern on a non-display part of a window plate; laminating a conductive electrode pattern layer, an electrode pattern, and a scattering preventative film, in this order, on the window plate; and connecting the electrode pattern to a terminal of a printed circuit board.

The non-conductive pattern is conventionally formed by screen printing using a squeegee, which includes placing an ink composition for forming a non-conductive pattern on a patterned screen, then, directly providing the ink composition for forming a non-conductive pattern on a window plate through a screen having an empty inner-space.

When forming the non-conductive pattern by screen printing as described above, this printing process must be executed two to eight times in order to ensure shielding effects through the non-conductive pattern. As a result, the pattern becomes thickened, which in turn increases the overall thickness of the touch screen panel. Due to a step height caused by the above conditions, there is difficulty in forming a conductive electrode pattern layer.

Further, the non-conductive pattern is formed on the completely processed window plate. In this regard, the processed window plate has holes for arranging a speaker and buttons therein, which causes problems with leaking ink through the holes of the window plate during screen printing.

Korean Patent Laid-Open Application No. 2011-0100888 discloses a static capacity film type touch screen panel having a reflective layer. However, this patent has proposed no alternative ideas or solutions to overcoming problems with conventional screen printing.

### SUMMARY

Accordingly, an object of the present invention is to provide a method for preparing a touch screen panel having a decreased thickness of a non-conductive pattern, thus reducing the failure rate caused by a step height resulting from the thickness.

Another object of the present invention is to provide a method for preparing a touch screen panel without leakage of ink through the holes of a window plate during formation of a non-conductive pattern.

Another object of the present invention is to provide a touch screen panel having a small thickness.

In order to accomplish the above objects, one or more embodiments of the present invention provides at least one of the followings:

(1) A method for preparing a touch screen panel, including forming a non-conductive pattern on a non-display part at one face of a window plate by offset printing.

(2) The method according to (1) above, wherein the window plate is formed from at least one of the materials selected from the group consisting of glass, polyethersulfone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), cellulose triacetate (TAC), and cellulose acetate propionate (CAP).

(3) The method according to (1) above, wherein the non-conductive pattern is a non-conductive color pattern or non-conductive shielding pattern.

(4) The method according to (3) above, wherein the non-conductive color pattern is formed using an ink composition for forming a non-conductive color pattern that includes a binder resin, coloring agent, polymerizable compound, polymerization initiator, and solvent.

(5) The method according to (3) above, wherein the non-conductive shielding pattern is formed using an ink composition for forming a non-conductive shielding pattern that includes a binder resin, shielding agent, polymerizable compound, polymerization initiator, and solvent.

(6) The method according to (4) or (5) above, wherein the ink composition for forming a non-conductive pattern has a viscosity ranging from 1 to 30 cps.

(7) The method according to (1) above, wherein the offset printing is reverse offset printing.

(8) The method according to (1) above, further including: forming a conductive electrode pattern layer on the window plate having the non-conductive pattern formed thereon; forming an electrode pattern on an area corresponding to the non-display part in the conductive electrode pattern layer; forming a scattering preventative film on the window plate having the conductive transparent electrode pattern layer and the electrode pattern formed thereon; and connecting a terminal of a printed circuit board to the electrode pattern.

(9) The method according to (8) above, wherein the conductive electrode pattern layer or electrode pattern is formed from at least one material selected from the group consisting of indium-tin oxide (ITO), indium-zinc oxide (IZO), zinc oxide (ZnO), indium-zinc-tin oxide (IZTO), cadmium-tin oxide (CTO), poly(3,4-ethyleneoxythiopene) (PEDOT), carbon nanotube (CNT), and a metal wire.

According to the method for preparing a touch screen panel of the present invention, the thickness of the non-conductive pattern is decreased, thus enabling the preparation of a thin touch screen panel.

In addition, according to the method for preparing a touch screen panel of the present invention, it is possible to enhance the reliability of a conductive electrode pattern layer at a lateral side of a non-conductive pattern during formation of a conductive electrode pattern.

Further, the method for preparing a touch screen panel of the present invention does not encounter leakage of ink through the holes of a window plate during formation of a non-conductive pattern, thus reducing failure rates.

### BRIEF DESCRIPTION OF THE DRAWINGS

The above summary and other objects, features, and alternate advantages of the present invention will be more clearly understood from the following detailed description, taken in conjunction with the accompanying drawings, in which:

FIG. 1 schematically illustrates one embodiment of a reverse offset printing mode with regards to formation of a non-conductive pattern; and

FIG. 2 schematically illustrates one example of a method for preparing a touch screen panel according to the present invention.

### DETAILED DESCRIPTION OF EMBODIMENTS

The present invention discloses a method for preparing a touch screen panel and, in particular, a method for preparing a touch screen panel, which includes forming a non-conductive pattern on a non-display part on one face of a window plate by offset printing, so that the thickness of the non-conductive pattern may be decreased producing a thin touch screen panel. In addition, it is possible to prevent leakage of ink through the holes of the window plate, and improve reliability of a conductive electrode pattern layer at a lateral side of the non-conductive pattern, thereby reducing failure rates.

Conventionally, a non-conductive pattern can be formed by screen printing. In this regard, in order to attain shielding effects through the non-conductive pattern, printing must be repeatedly executed to increase the thickness of the pattern. Accordingly, due to a step height caused by the thickness, there are problems associated with difficulty in forming a conductive electrode pattern layer, an increase in overall thickness of a touch screen panel, and ink leakage through the holes of a window plate.

Conversely, the method for preparing a touch screen panel of the present invention includes forming a non-conductive pattern by offset printing, thereby preventing ink leakage through the holes of a window plate and improving the reliability of an electrode pattern layer, which in turn reduces failure rates.

Hereinafter, one embodiment of the present invention will be described in detail with reference to the drawings.

The method for preparing a touch screen panel of the present invention may include forming a non-conductive pattern on a non-display part on one face of a window plate by offset printing.

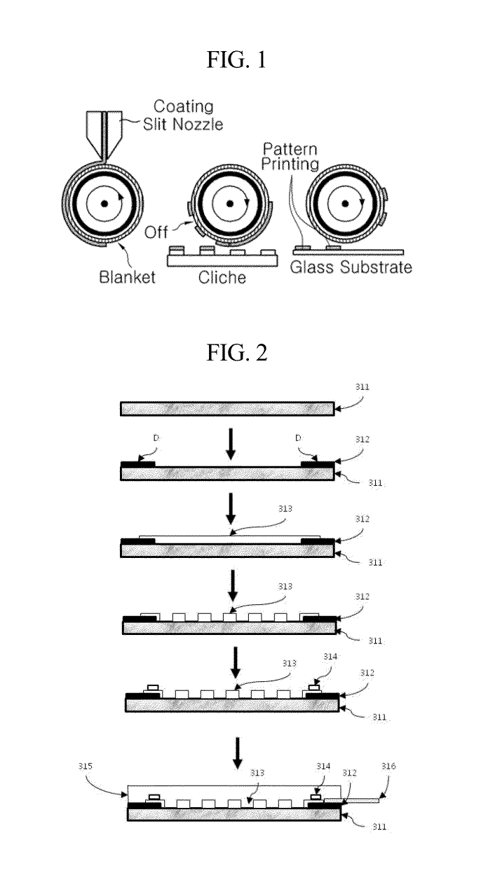

Offset printing is a process of transferring ink images on a rubber blanket and printing the same on a subject to be printed. Non-limiting types of offset printing include, for example, gravure offset printing, reverse offset printing, or the like. Preferably, reverse offset printing is used. FIG. 1 schematically illustrates one embodiment of the reverse offset printing mode. More particularly, this method may be executed by applying an ink composition for forming a non-conductive pattern to a blanket, contacting the blanket with an embossed cliché to form a desired pattern, and transferring the formed pattern to one face of a window plate.

A conventional non-conductive pattern was formed by a general screen printing process, wherein an ink composition for forming a non-conductive pattern is placed on a patterned screen, and the ink composition for forming a non-conductive pattern is directly provided on a window plate through a screen having an empty inner-space using a squeegee.

In screen printing, since a pigment typically includes large particles and has a rough surface, printing must be repeatedly conducted two to eight times in order to attain the desired shielding effects through the non-conductive pattern. Accordingly, by repeatedly printing four times, the thickness of the non-conductive pattern increased to about 20 μm, hence causing problems associated with increasing the overall thickness of the touch screen panel.

The conductive electrode pattern layer, typically included in the touch screen panel, is formed to cover the non-conductive pattern and window plate. However, since the non-conductive pattern was thickened, the reliability of the conductive electrode pattern layer at a lateral side of the non-conductive pattern is diminished. Furthermore, there are problems with ink leakage through the holes of the window plate.

However, the method for forming a touch screen panel of the present invention may form a non-conductive pattern by offset printing, wherein a pigment having a small particle size is used, and a process of coating a blanket with the pigment and transferring the pigment on the same is employed, so that the touch screen panel has a uniform surface flatness, and the smaller pigment particles ensure uniform packing effects, thus accomplishing the desired shielding effects by the non-conductive pattern, even if printing is executed only once.

Accordingly, the non-conductive pattern formed, as described above, may have a thickness of 1.5 to 2 μm, thus producing a thin touch screen panel and improving the reliability of a conductive electrode pattern formed on the non-conductive pattern.

Further, according to the design of the cliché, the transferring is executed in one-to-one, thus not causing problems of ink leakage through the holes of a window plate.

FIG. 2 schematically illustrates one example of the method for preparing a touch screen panel according to the present invention. Hereinafter, the present invention will be described in detail with reference to FIG. 2.

A window plate 311 is a part receiving contact input from a specific object such as the human fingers of a user or a stylus pen, etc., in order to secure the outer appearance of a touch screen panel.

The window plate 311 may be prepared from any material, without limitation, so long as the material has the durability to sufficiently protect the touch screen panel from external forces, and allow a user to adequately view the display. The material may include, for example, glass, polyethersulfone (PES), polyacrylate (PAR), polyetherimide (PEI), polyethylene napthalate (PEN), polyethylene terepthalate (PET), polyphenylene sulfide (PPS), polyallylate, polyimide, polycarbonate (PC), cellulose triacetate (TAC), cellulose acetate propionate (CAP), or the like, which can be used alone or in combination with two or more thereof.

A non-conductive pattern 312 is formed on a non-display part on one face of the window plate 311.

In order to hide an inner board and/or wiring of a device, the non-conductive pattern 312 has an opaque ornamental layer formed on a display part along the periphery of the window plate 311, in such a way that the display part as a touch area is defined as the center of the window plate 311.

The non-conductive pattern 312 according to the present invention may be a non-conductive color pattern or non-conductive shielding pattern.

The non-conductive color pattern may be formed using an ink composition for forming a non-conductive color pattern, generally used in offset printing, which includes a binder resin, coloring agent, polymerization initiator, solvent and the like.

Coloring agents are without limitation, so long as the coloring agents can express a color required by a user, and may include, for example: red, green, or blue dyes or pigments; yellow, orange, violet, or brown dyes or pigments for combinations of colors; black pigments; carbon black, and the like, which can be used alone or in combination with two or more thereof.

The coloring agents may further include metal powder, white pigments, fluorescent pigments, etc., as necessary.

The pigments may be inorganic pigments or organic pigments.

Inorganic pigments are without limitation, and may include, for example, barium sulfate, lead sulfate, titanium oxide, yellow lead, Bengal lead, calcium carbonate, chromium oxide, carbon black, or the like.

Organic pigments are without limitation, and may include pigments listed by the Color Index (C.I.) numbers below.

Red pigments may include, for example, C.I. pigment red 1, 2, 3, 4, 5, 6, 8, 9, 12, 14, 15, 17, 22, 23, 31, 37, 38, 41, 48:1, 48:2, 48:3, 49, 50:1, 52:1, 53, 57:1, 58:4, 60, 63, 64, 68, 81, 88, 90:1, 112, 114, 122, 123, 144, 146, 147, 149, 150, 151, 166, 168, 170, 175, 176, 177, 178, 179, 181, 185, 187, 188, 190, 193, 194, 202, 207, 208, 209, 214, 216, 220, 221, 224, 242, 243, 245, 247, 254, 255, 264, 272, or the like.

Green pigments may include, for example, C.I. pigment green 2, 7, 8, 13, 36, 54, or the like.

Blue pigments may include, for example, C.I. pigment blue 1, 15:1, 15:2, 15:3, 15:4, 15:6, 16, 17, 25, 56, 60, 66, 75, 79, or the like.

Yellow pigments may include, for example, C.I. pigment yellow 1, 2, 3, 4, 5, 6, 12, 13, 14, 16, 17, 24, 55, 65, 73, 74, 81, 83, 87, 93, 94, 95, 97, 100, 101, 105, 108, 109, 110, 116, 120, 127, 128, 129, 133, 138, 139, 147, 148, 150, 151, 153, 154, 155, 166, 168, 169, 170, 172, 173, 174, 175, 176, 180, 185, 193, 194, 202, or the like.

Orange pigments may include, for example, C.I. pigment orange 1, 2, 5, 13, 16, 17, 19, 22, 24, 34, 36, 38, 39, 43, 46, 48, 61, 62, 64, 65, 67, 69, 73, 77, or the like.

Violet pigments may include, for example, C.I. pigment violet 1, 2, 3, 5, 19, 23, 29, 31, 32, 37, 39, 50, or the like.

Brown pigments may include, for example, C.I. pigment brown 1, 22, 23, 25, 27, or the like.

Black pigments may include, for example, C.I. pigment black 1, 7, 31, 32, or the like.

Dyes are without limitation, and may include, for example, azo dyes, anthraquinone dyes, phthalocyanine dyes, quinonimine dyes, quinoline dyes, nitro dyes, carbonyl dyes, methyne dyes, or the like.

Azo dyes are without limitation, and may include, for example, C.I. acid yellow 11, C.I. acid orange 7, C.I. acid red 37, C.I. acid red 180, C.I. acid blue 29, C.I. direct red 28, C.I. direct red 83, C.I. direct yellow 12, C.I. direct orange 26, C.I. direct green 28, C.I. direct green 59, C.I. reactive yellow 2, C.I. reactive red 17, C.I. reactive red 120, C.I. reactive black 5, C.I. disperse orange 5, C.I. disperse red 58, C.I. disperse blue 165, C.I. basic blue 41, C.I. basic red 18, C.I. mordant red 7, C.I. mordant yellow 5, C.I. mordant black 7, or the like.

Anthraquinone dyes are without limitation, and may include, for example, C.I. bat blue 4, C.I. acid blue 40, C.I. acid green 25, C.I. creative blue 19, C.I. creative blue 49, C.I. disperse red 60, C.I. disperse blue 56, C.I. disperse blue 60, or the like.

Phthalocyanine dyes are without limitation, and may include, for example, C.I. pad blue 5, or the like.

Quinonimine dyes are without limitation, and may include, for example, C.I. basic blue 3, C.I. basic blue 9, or the like.

Quinoline dyes are without limitation, and may include, for example, C.I. solvent yellow 33, C.I. acid yellow 3, C.I. disperse yellow 64, or the like.

Nitro dyes are without limitation, and may include, for example, C.I. acid yellow 1, C.I. acid orange 3, C.I. disperse yellow 42, or the like.

Particular examples of the above dyes, pigments, and carbon black may include, but are not limited to, Mitsubishi carbon black M1000, Mitsubishi carbon black MA-100, Mitsubishi carbon black #40, Vitoria pure blue (42595), oramine O (41000), catilon brilliant flavine (basic 13), rhodamine 6GCP (45160), rhodamine B (45170), sakuranin OK 70:100 (50240), erioglaucine X (42080), NO. 120/lionel yellow (21090), lionel yellow GRO (21090), symuler fast yellow GRO (21090), symuler fast yellow 8GF (21105), benzidine yellow 4J-564D (21095), paliotol yellow L0960 (pigment yellow 139), yellow pigment E4-GN (pigment yellow 150 derivative), symuler fast red 4015 (12355), lionel red 7B4401 (15850), fastogen blue JGR-L (74160), lionel blue SM (26150), lionel blue ES (pigment blue 15:6, pigment blue 1536), lionogen red GD (pigment red 168, pigment red 108), chromophthal red A2B (pigment red 177), ilgapore red B-CF (pigment red 254), heliogen green L8730 (pigment green 7), lionel green 2YS (pigment green 36), or the like.

The binder resin plays a role of supporting the pattern and may be a copolymer of a monomer having a carboxyl group, and another monomer having an unsaturated bond.

The monomer having a carboxyl group is an unsaturated carboxylic acid having at least one carboxyl group in the molecule and may include, for example: a monocarboxylic acid such as acrylic acid, methacrylic acid, crotonic acid, etc.; dicarboxylic acids such as fumaric acid, metaconic acid, itaconic acid, etc.; and anhydrides thereof, and the like.

Monomers having an unsaturated bond are without limitation so long as any monomer having an unsaturated double bond is copolymerizable with the monomer having a carboxyl group. Particular examples thereof may include: unsaturated carboxylic acid ester compounds such as methyl(meth)acrylate, ethyl(meth)acrylate, butyl(meth)acrylate, 2-hydroxyethyl(meth)acrylate, etc.; unsubstituted or substituted alkylester compounds of unsaturated carboxylic acids such as aminoethyl(meth)acrylate; unsaturated carboxylic acid ester compounds having alicyclic substituents such as cyclopentyl(meth)acrylate, cyclohexyl(meth)acrylate, methylcyclohexyl(meth)acrylate, cycloheptyl(meth)acrylate, cyclooctyl(meth)acrylate, cyclopentenyl(meth)acrylate, cyclohexenyl(meth)acrylate, cycloheptenyl(meth)acrylate, cyclooctenyl(meth)acrylate, isobornyl(meth)acrylate, adamantly(meth)acrylate, norbornyl(meth)acrylate, etc.; unsaturated carboxylic acid ester compounds having thermo-curable substituents such as 3-methyl-3-(meth)acryloxymethyloxetane, 3-ethyl-3-(meth)acryloxymethyloxetane, 3-methyl-3-(meth)acryloxyethyloxetane, etc.; unsaturated glycidyl carboxylic acid ester compounds such as glycidyl(meth)acrylate, etc.; unsaturated carboxylic acid ester compounds having aromatic ring-containing substituents such as benzyl(meth)acrylate, phenoxy(meth)acrylate, etc.; aromatic vinyl compounds such as styrene, vinyl toluene, α-methyl styrene, etc.; carboxylic acid vinylesters such as vinyl acetate, vinyl propionate, etc.; acrylonitrile derivatives such as (meth)acrylonitrile, α-chloroacrylonitrile, etc., which can used alone or in combination with two or more thereof.

Examples of copolymers may include, but are not limited to, 3-ethyl-3-methacryloxymethyloxetane/benzyl methacrylate/methacrylic acid copolymer, 3-ethyl-3-methacryloxymethyloxetane/benzyl methacrylate/methacrylic acid/styrene copolymer, 3-ethyl-3-methacryloxymethyloxetane/methyl methacrylate/methacrylic acid copolymer, 3-ethyl-3-methacryloxymethyloxetane/methyl methacrylate/methacrylic acid/styrene copolymer, etc.

Polymerizable compounds are without limitation, and may be any compound generally known or used in the art, for example, a compound having an epoxy group hardened by heat.

Compounds having an epoxy group are without limitation, and may include, for example, a curable monomer having an epoxy(meth)acrylate functional group structure.

Curable monomers having an epoxy(meth)acrylate functional group may be any epoxy(meth)acrylate selected from commercially available compounds, including for example, compounds having two epoxy acrylate groups or four epoxy acrylate groups within the same molecule.

Polymerization initiators used herein are without limitation, and may include any polymerization initiator known or used in the art, for example, triazines, acetophenones, xanthones, benzoins, imidazoles, etc., which can be used alone or in combination with two or more thereof.

Particular examples of polymerization initiators may include 2,4-bistrichloromethyl-6-p-methoxystyryl-s-triazine, 2-p-methoxystyryl-4,6-bistrichloromethyl-s-triazine, 2,4-trichloromethyl-6-triazine, 2,4-trichloromethyl-4-methylnaphthyl-6-triazine, benzophenone, p-(diethylamino)benzophenone, 2,2-dichloro-4-phenoxyacetophenone, 2,2-diethoxyacetophenone, 2,2-dibutoxyacetophenone, 2-hydroxy-2-methylpropiophenone, p-t-butyl trichloroacetophenone, 2-methylthioxanthone, 2-isobutylthioxanthone, 2-dodecylthioxanthone, 2,4-dimethylthioxanthone, 2,4-diethylthioxanthone, 2,2′-bis(2-chlorophenyl)-4,4′,5,5′-tetraphenyl-1,2′-biimidazole compounds, etc., which can be used alone or in combination with two or more thereof.

Solvents used herein are without limitation, and may include, for example: ethyleneglycol monoalkylethers such as ethyleneglycol monomethylether, ethyleneglycol monoethylether, ethyleneglycol monopropylether, ethyleneglycol monobutylether, etc.; diethyleneglycol dialkylethers such as diethyleneglycol dimethylether, diethyleneglycol diethylether, diethyleneglycol dipropylether, diethyleneglycol dibutylether, etc.; alkyleneglycol alkylether acetates such as propyleneglycol monomethylether acetate, propyleneglycol monoethylether acetate, propyleneglycol monopropylether acetate, etc.; alkyleneglycol alkylethers such as propyleneglycol monomethylether, propyleneglycol monoethylether, propyleneglycol monopropylether, etc.; (alkoxy)alkylesters such as ethyl acetate, ethyl lactate, methyl cellosolve acetate, ethyl cellosolve acetate, methoxybutyl acetate, methoxypentyl acetate, etc.; aromatic hydrocarbons such as benzene, toluene, xylene, etc.; ketones such as methylethylketone, acetone, methylamylketone, methylisobutylketone, cyclohexanone, etc.; alcohols such as ethanol, propanol, butanol, hexanol, cyclohexanol, ethyleneglycol, glycerin, etc., which can be used alone or in combination with two or more thereof.

The non-conductive shielding pattern may be formed using an ink composition for forming the non-conductive shielding pattern generally used in offset printing, which includes a binder resin, shielding agent, polymerizable compound, polymerization initiator, solvent, and the like.

The shielding agent is without limitation so long as it has insulating properties and shielding effects, and may include, for example: black or white achromatic color pigments; and pigments expressing black or white by mixing the same, which can be used alone or in combination with two or more thereof.

The pigments expressing black or white by mixing the same are without limitation, and may include, for example, water-soluble azo-pigments, insoluble azo-pigments, phthalocyanine pigments, quinacridone pigments, isoindolinone pigments, isoindoline pigments, perylene pigments, perinone pigments, dioxazine pigments, anthraquinone pigments, dianthraquinonyl pigments, anthrapyrimidine pigments, anthanthrone pigments, indanthrone pigments, pyranthrone pigments, diketopyrrolopyrrole pigments, etc., which can be used alone or in combination with two or more thereof.

More particularly, C.I. pigment yellow 20, 24, 31, 53, 83, 86, 93, 94, 109, 110, 117, 125, 137, 138, 139, 147, 148, 150, 153, 154, 166, 173, 180, and 185; C.I. pigment orange 13, 31, 36, 38, 40, 42, 43, 51, 55, 59, 61, 64, 65, and 71; C.I. pigment red 9, 97, 105, 122, 123, 144, 149, 166, 168, 176, 177, 180, 192, 215, 216, 224, 242, 254, 255, and 264; C.I. pigment violet 14, 19, 23, 29, 32, 33, 36, 37, and 38; C.I. pigment blue 15 (15:3, 15:4, 15:6, etc.), 21, 28, 60, 64, and 76; C.I. pigment green 7, 10, 15, 25, 36, 47, and 58; C.I. pigment brown No. 28; C.I. pigment black 1 and 7, etc., which can be used alone or in combination with two or more thereof.

Optionally, the shielding agent may further include carbon black, aniline black, chromium oxide, iron oxide, titanium black, or mixtures thereof.

Other components except for the shielding agent may be the same components as those included in an ink composition for forming a non-conductive color pattern.

The inventive non-conductive pattern formed using the above ink composition may play a role in providing an external color for a device or the hiding and shielding of an inner board and wiring of the device.

The ink composition for forming a non-conductive pattern may have a viscosity ranging from 1 cps to 30 cps, preferably, 5 cps to 10 cps. If the viscosity of the ink composition for forming a non-conductive pattern is within the above range, the ink stability (a process maintaining the ability of the ink) is maintained during the appropriate ink coating, thereby enabling uniform coating and printing.

After formation of the non-conductive pattern 312, the resulting product is subjected to further typical processes associated with preparing a touch screen panel to thus produce a complete touch screen panel.

According to one embodiment of the method for preparing a touch screen panel, after formation of the non-conductive pattern, a conductive electrode pattern layer 313 is formed on a window plate 311 having the non-conductive pattern 312 formed thereon.

The conductive electrode pattern layer 313 may play a role in detecting static electricity generated from the body of a human when his or her finger contacts the display part as a touch area of an image sensor, thereby converting it to electric signals.

A conductive material used for forming the conductive electrode pattern layer 313 is without limitation, and may include, for example, indium-tin oxide (ITO), indium-zinc oxide (IZO), zinc oxide (ZnO), indium-zinc-tin oxide (IZTO), cadmium-tin oxide (CTO), poly(3,4-ethylenedioxythiopene) (PEDOT), carbon nanotube (CNT), metal wire, etc., which can be used alone or in combination with two or more thereof.

Metals used in the metal wire are without limitation, and may include, for example, silver, gold, aluminum, copper, iron, nickel, titanium, tellurium, chromium, etc., which can be used alone or in combination with two or more thereof.

The method for forming the conductive electrode pattern layer 313 is without limitation. The conductive electrode pattern layer may be formed by, for example, photolithography using an etching paste, inkjet printing, screen printing, pad printing, gravure printing, flexography printing, offset printing, stencil printing, imprinting, or the like.

Next, an electrode pattern 314 may be formed on an area corresponding to the non-display part in the conductive electrode pattern layer 313.

The electrode pattern 314 plays a role in delivering the electrical signal generated from the conductive electrode pattern layer 313 to flexible printed circuit board (FPCB), IC chips, or the like, by touching the display part of the window plate 311.

The electrode pattern 314 may be formed from the same material by the same method as used for the conductive electrode pattern layer 313.

Thereafter, a scattering preventative film 315 may be formed on the window plate 311 having the conductive transparent electrode pattern layer 313 and electrode pattern 314 formed thereon.

The scattering preventative film 315 may play a role in protecting both the patterns 313 and 314, and preventing the same from being scattered when the window is broken.

Materials of the scattering preventative film 315 are without limitation so long as the materials are transparent and provide durability, and may include, for example, polyethylene terephthalate (PET).

A method for forming the scattering preventative film 315 is without limitation, and may include, for example, spin coating, roll coating, spray coating, dip coating, flow coating, doctor blade and dispensing, inkjet printing, screen printing, pad printing, gravure printing, offset printing, flexography printing, stencil printing, imprinting, and the like.

Next, a terminal 316 of a printed circuit board is connected to the electrode pattern 314.

With respect to the printed circuit board, various types of printed circuit boards may be used, for example, a flexible printed circuit board (FPCB) may be used.

The method for preparing a touch screen panel according to present invention, which includes the above described steps, may decrease the thickness of a non-conductive pattern to produce a thin touch screen panel, prevent ink leakage through the holes of a window plate 311, and improve the reliability of a conductive electrode pattern layer 313 at a lateral side of the non-conductive pattern, thereby reducing failure rates.

What is claimed is:

1. A method for preparing a touch screen panel, comprising:
forming a non-conductive pattern on a non-display part on one face of a window plate by offset printing.

2. The method according to claim 1, wherein the window plate is formed from the materials selected from the group consisting of glass, polyethersulfone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), cellulose triacetate (TAC), cellulose acetate propionate (CAP), and a combination thereof.

3. The method according to claim 1, wherein the non-conductive pattern is a non-conductive color pattern or non-conductive shielding pattern.

4. The method according to claim 3, wherein the non-conductive color pattern is formed using an ink composition for forming a non-conductive color pattern that includes a binder resin, coloring agent, polymerizable compound, polymerization initiator, and solvent.

5. The method according to claim 3, wherein the non-conductive shielding pattern is formed using an ink composition for forming a non-conductive shielding pattern that includes a binder resin, shielding agent, polymerizable compound, polymerization initiator, and solvent.

6. The method according to claim 4, wherein the ink composition for forming a non-conductive pattern has a viscosity ranging from 1 to 30 cps.

7. The method according to claim 5, wherein the ink composition for forming a non-conductive pattern has a viscosity ranging from 1 to 30 cps.

8. The method according to claim 1, wherein the offset printing is reverse offset printing.

9. The method according to claim 1, further comprising:
forming a conductive electrode pattern layer on the window plate having the non-conductive pattern formed thereon;
forming an electrode pattern on an area corresponding to the non-display part in the conductive electrode pattern layer;
forming a scattering preventative film on the window plate having the conductive transparent electrode pattern layer and the electrode pattern formed thereon; and
connecting a terminal of a printed circuit board to the electrode pattern.

10. The method according to claim 9, wherein the conductive electrode pattern layer or electrode pattern is formed of material selected from the group consisting of indium-tin oxide (ITO), indium-zinc oxide (IZO), zinc oxide (ZnO), indium-zinc-tin oxide (IZTO), cadmium-tin oxide (CTO), poly(3,4-ethyleneoxythiopene) (PEDOT), carbon nanotube (CNT), a metal wire, and a combination thereof.
